(19) United States
(12) Patent Application Publication
(10) Pub. No.: US 2021/0345628 A1
(43) Pub. Date: Nov. 11, 2021

(54) APPARATUS AND PROCESS FOR THAWING MEAT

(71) Applicant: Cargil Animal Protein (Anhui) Co., Ltd., Shanghai (CN)

(72) Inventors: Huijuan WANG, Nanjing, Jiangsu (CN); Jian WANG, Shanghai (CN)

(73) Assignee: Cargil Animal Protein (Anhui) Co., Ltd., Shanghai (CN)

(21) Appl. No.: 17/277,841

(22) PCT Filed: Sep. 19, 2018
(86) PCT No.: PCT/CN2018/106526

§ 371 Date: Mar. 19, 2021

(51) Int. Cl. A23B 4/07; A23L 3/00; A23L 3/365

(52) U.S. Cl. CPC A23B 4/07; A23V 2002/00; A23L 3/365; A23L 3/001

(57) ABSTRACT

An apparatus for thawing meat with effective air circulation has temperature control of the circulated air through sensing of the temperature by a plurality of thermal sensors as described herein chamber to thaw at least 10 metric tons of meat from a frozen internal temperature of no more than −18° C. to a thawed internal temperature of from −2° C. to 4.4° C. while maintaining the surface temperature of meat at a temperature of less than 4.4° C. throughout the thawing process. The apparatus is configured so that no new air and no added moisture is introduced to the thawing chamber during the thawing cycle. Methods for thawing meat using the apparatus are also described.

### FIELD

The present invention relates to thawing of meat.

### BACKGROUND

Meat is an important component of diet around the world, and therefore there is a high demand for safe, high quality meat products. Meat is often frozen at the site where the meat is processed to assure safe transport and delivery of meat to locations where the meat is prepared and served. Various techniques have been used to defrost the frozen meat, including thawing the meat at room temperature.

Chinese application 104824116, published on Dec. 8, 2017 describes an intelligent frozen meat unfreezing library which is composed of an electrical system, an air circulation system, a humidity control system, a temperature control system and a temperature and humidity data acquisition system, a microcomputer intelligent control system and a microcomputer intelligent control system, wherein low-pressure cleaning steam is used as a working medium to unfreeze the frozen meat.

U.S. Pat. No. 7,119,306 describes a food thawing cabinet that includes at least one thawing chamber and one or more wall blowers and a heater for producing a controlled high volume of air flow over food product, with the heater controlled in a cyclic manner.

### SUMMARY

It has been found that large amounts of meat can be efficiently thawed by using an apparatus with effective air circulation as described herein, with temperature control of the circulated air through sensing of the temperature by a plurality of thermal sensors as described herein chamber to thaw at least 10 metric tons of meat from a frozen internal temperature of no more than −18° C. to a thawed internal temperature of from −2° C. to 4.4° C. while maintaining the surface temperature of meat at a temperature of less than 4.4° C. throughout the thawing process. The apparatus is configured so that no new air and no added moisture is introduced to the thawing chamber during the thawing cycle.

In an aspect, an apparatus for thawing meat comprises a thawing chamber defined by a floor, at least four walls and a ceiling, the thawing chamber having a length of at least 6 meters, a width of at least 1.9 meters, and a height of at least 1.9 meters. An air circulation fan unit is operably connected by an air transfer conduit to at least 6 air outlet openings for introducing air into the thawing chamber and at least 1 air intake opening for removing air from the thawing chamber. The air circulation fan unit is capable of moving a volume of air in and out of the thawing chamber as a closed system at a rate of at least 900 cubic meters per hour. An air heating unit and an air cooling unit are operably connected to the air transfer conduit. An array of thermal sensors in the thawing chamber is provided comprising a) ambient air temperature sensors configured to measure the temperature of ambient air in at least three locations in the thawing chamber, b) a meat surface temperature sensor configured to measure the temperature of a surface of a sample of meat in the thawing chamber, and c) a meat core temperature sensor configured to measure the internal temperature of a sample of meat in the thawing chamber. A climate control unit is operably connected to the air circulation fan unit, the air heating unit, the air cooling unit and the thermal sensors. The apparatus is capable of controlling the climate of the thawing chamber to thaw at least 10 metric tons of meat from a frozen internal temperature of no more than −18° C. to a thawed internal temperature of from −2° C. to 4.4° C. while maintaining the surface temperature of meat at a temperature of less than 4.4° C. throughout the thawing process. The apparatus is configured so that no new air and no added moisture is introduced to the thawing chamber during the thawing cycle.

Methods of thawing meat are also provided, comprising providing an apparatus as described herein and disposing at least 10 metric tons of frozen meat having a frozen internal temperature of no more than −18° C. in the thawing chamber. The air heating unit and the air circulation fan unit are operated to circulate heated air through the thawing chamber at a rate of at least 900 cubic meters per hour while monitoring the temperature of the ambient air in the thawing chamber in at least three locations, the surface temperature of meat to be thawed, and the internal temperature of meat to be thawed. The climate of the thawing chamber is controlled to thaw the meat to a thawed internal temperature of from −2° C. to 4.4° C. while maintaining the surface temperature of meat at a temperature of less than 4.4° C. throughout the thawing process by controlled operation of the air heating unit and the air cooling unit to maintain a suitable thawing temperature. In an aspect, the method is carried out so that all of the meat disposed in the thawing chamber is thawed in less than 24 hours.

The apparatus as described herein has been found to thaw large amounts of meat in a very short time, with excellent quality characteristics. The apparatus comprises elements that afford the ability to highly control the temperature of the meat during the thawing process, so that the meat is not unevenly thawed. Moreover, precise temperature control permits the meat to be thawed without causing the surface of the meat product to experience an undesirably high surface temperature. It has been found that meat that is unevenly thawed develops undesired organoleptic properties and in particular develops adverse texture characteristics. It further has been found that meat that experiences an undesirably high surface temperature during the thawing process likewise develops undesired organoleptic properties and in particular develops adverse texture characteristics. The undesirable organoleptic properties of meat that has been thawed in an improper manner are experienced when the surface temperature of the meat is permitted to rise above the presently indicated acceptable surface temperature ranges during the thawing process, even when this surface temperature is not so high as to cause premature “cooking” of the surface.

It additionally has been discovered that the presence of excess moisture in the thawing chamber during the thawing process is undesirable, because moisture promotes pathogen growth and also can lead to adverse meat color. It also has been discovered that there is a significant advantage in preventing introduction of new air to the thawing chamber during the thawing cycle (i.e., providing a closed environment system during thawing), because such air introduction provides the opportunity for new pathogens to be introduced.

### BRIEF DESCRIPTION OF THE DRAWINGS

The accompanying drawings, which are incorporated in and constitute a part of this application, illustrate several aspects of the invention and together with a description of the aspects serve to explain the principles of the invention. A brief description of the drawings is as follows:

FIG. 1 is a perspective view of an apparatus for thawing meat.

FIG. 2 is a side view of the apparatus for thawing meat shown in FIG. 1.

FIG. 3 is a graph showing temperature data of an example of a process for thawing meat using an apparatus as described herein.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

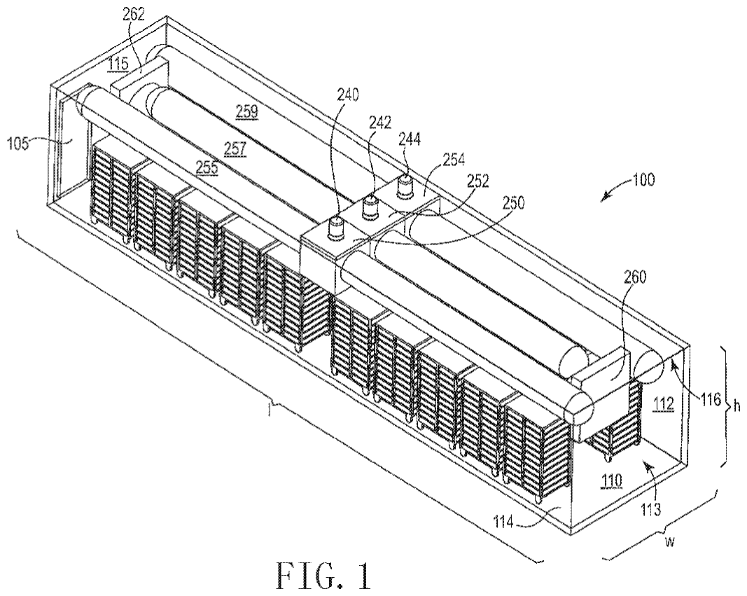

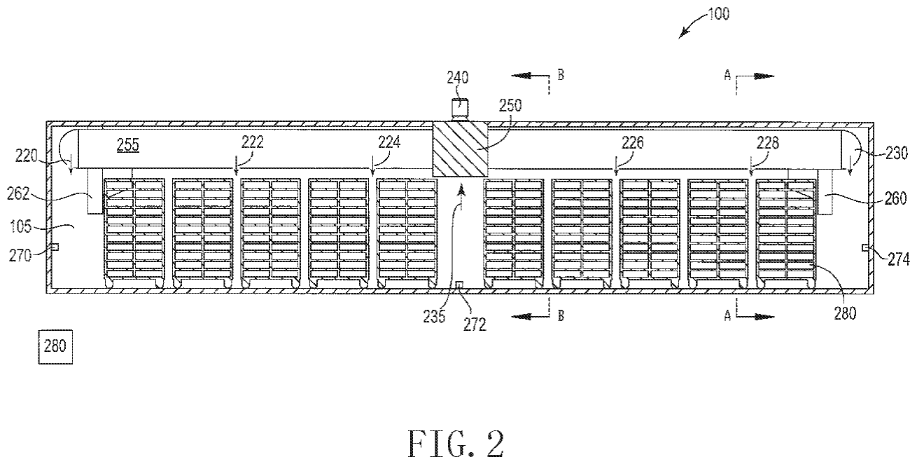

Turning now to the Figures, FIG. 1 is a perspective view of an aspect of an apparatus for thawing meat 100, and FIG. 2 is a side view of the aspect of the apparatus for thawing meat 100 shown in FIG. 1. As shown in FIG. 1 and FIG. 2, the apparatus 100 comprises a thawing chamber 105 defined by a floor 110, at least four walls 112, 113, 114 and 115, and a ceiling 116. In an aspect, the thawing chamber 105 has a length l of at least 6 meters, a width w of at least 1.9 meters, and a height h of at least 1.9 meters. In an aspect, the thawing chamber has a length l of from 6 meters to 25 meters, a width w of 1.9 meters to 4 meters, and a height h of 1.9 meters to 5 meters. In an aspect, the thawing chamber has a length l of from 7 meters to 20 meters, a width w of 2 meters to 4 meters, and a height h of 2 meters to 3 meters.

As shown in FIG. 2, air circulation fan unit 240 is operably connected by an air transfer conduit 255 to at least 6 air outlet openings 220, 222, 224, 226, 228 and 230 for introducing air into the thawing chamber 105 and at least 1 air intake opening 235 for removing air from the thawing chamber 105. In an aspect, air transfer conduit 255 is fabricated from food grade cloth, i.e. cloth that is deemed to be safe for food contact under relevant regulations of the jurisdiction of use, such as 21 CFR Part 175 in the United States. In an aspect, the food grade cloth comprises at least one component that inhibits the growth of bacteria in the cloth. In an aspect, the food grade cloth comprises at least one natural fiber component that exhibits natural bacterial growth inhibition properties. In an aspect, the food grade cloth comprises at least one inorganic component, such as silver, that exhibits bacterial growth inhibition properties. In an aspect, the food grade cloth comprises at least one organic component, such as an organic chemical antibiotic, that exhibits bacterial growth inhibition properties. In an aspect, air transfer conduit 255 is fabricated from food grade cloth that is removably mounted on a frame system. This configuration is particularly advantageous over the use of metal (e.g. stainless steel) ductwork, because the air transfer conduit is easy to remove and clean or replace with almost no system downtime. In an aspect during use, air transfer conduit 255 is periodically removed and cleaned. In an aspect during use, air transfer conduit 255 is periodically removed and cleaned in a period of between 1 and 3 months. Additionally, construction of the air transfer conduit from food grade cloth is significantly less complicated due to the semi-permeable nature of the cloth, eliminating the need to incorporate air pressure balance channels to facilitate air flow as is require in a solid ductwork air flow system.

In an aspect, the air circulation fan unit 240 is capable of moving a volume of air in and out of the thawing chamber as a closed system at a rate of at least 900 cubic meters per hour. In an aspect, the air circulation fan unit 240 is capable of moving a volume of air inside the thawing chamber as a closed system at a rate of from 9600 cubic meters per hour to 48000 cubic meters per hour.

The air circulation fan unit 240 may be any appropriate device for circulating air, such as a fan, positive displacement blower, helical screw blower, centrifugal blower, high speed blower, or a regenerative blower.

In an aspect, the air outlet openings are spaced apart a distance of from about 1 meter to about 5 meters. In an aspect, the air outlet openings are spaced apart a distance of from about 1 meter to about 2 meters, with the number of air outlet openings provided in each air transfer conduit being determined by the length of the air transfer conduit.

As shown in FIG. 1, in an aspect, apparatus 100 may comprise of air transfer conduit arrays. As shown a plurality of air circulation fan units 240, 242 and 244 are operably connected by respective air transfer conduits 255, 257 and 259 to air outlet openings (not shown) and air intake openings (not shown) for moving a volume of air inside thawing chamber 105. In an aspect, the plurality of air circulation fan units are capable of moving a volume of air in and out of thawing chamber 105 as a closed system at a rate of at least 9600 cubic meters per hour. In an aspect, the plurality of air circulation fan units are capable of moving a volume of air in and out of thawing chamber 105 as a closed system at a rate of from 9600 cubic meters per hour to 48000 cubic meters per hour.

In an aspect, the at least 6 air outlet openings and the at least 1 air intake opening are located proximate to the ceiling. In an aspect, the at least 6 air outlet openings and the at least 1 air intake opening are located within 2 meters of the ceiling. In an aspect, the at least 6 air outlet openings and the at least 1 air intake opening are located within 1 meter of the ceiling. In an aspect, the at least 1 air intake opening is centrally located in the thawing chamber, and the at least 6 air outlet openings are symmetrically located with respect to the at least 1 air intake opening. In an aspect, the at least 1 air intake opening is centrally located in the thawing chamber, and is configured to draw air from the thawing chamber into the air heating unit that additionally comprises the air circulation fan unit and the air circulation fan unit is operably connected with air circulation tunnels comprising the at least 6 air outlet openings, the air circulation tunnels extending from the air circulation fan unit substantially parallel to the ceiling of the chamber toward opposing walls. It has been discovered that the configuration wherein the air is internally circulated by drawing in air from the center of the thawing chamber reintroducing the heated air into the thawing chamber at a plurality of outlets spaced from the center of the thawing chamber provides effective and efficient circulation of the air.

In an aspect, the apparatus is constructed in an existing room of a building. In an aspect, the apparatus is constructed as a stand-alone container (similar to a shipping container) that can be transported to a site after assembly or partial assembly.

At least one air heating unit is operably connected to the air transfer conduit to heat the air to be circulated in the thawing chamber. In an aspect, the air heating unit is an electrical heating element. In an aspect, the air heating unit is a heat exchanger wherein air passes over a heat transfer surface that is heated by, for example, a liquid heated by electricity, natural gas or the like as will be apparent to the artisan. As shown in FIG. 2, air heating unit 250 is centrally located and operably connected to air transfer conduit 255 to heat the air to be circulated in thawing chamber 105. Air heating unit 250 is operably connected to air circulation fan unit 240, which causes air to traverse air heating unit 250 and circulate though thawing chamber 240. As shown in FIG. 1, in an aspect, apparatus 100 comprises a plurality of air heating unit 250, 252 and 254 that are operably connected by respective air transfer conduits 255, 257 and 259 to heat the air to be circulated in thawing chamber 105.

At least one air cooling unit is operably connected to the air transfer conduit to cool the air to be circulated in the thawing chamber. The air cooling unit enables precise control of the temperature of the air in the thawing chamber, and in particular rapid cooling of the thawing chamber in the event that the temperature of the meat, and particular the temperature of a surface of a sample of meat in the thawing chamber, increases too quickly. Additionally, the air cooling unit optionally enables maintenance of the temperature of the thawing chamber at a cool, low temperature suitable for long term storage of the meat in the thawing chamber after completion of the thawing process for any needed length of time.

In an aspect, the air cooling unit is a refrigeration system, including a compressor, a condenser coil, and an evaporator with its own associated blower. As shown in FIG. 2, first air cooling unit 260 is located on one side of the thawing chamber and is operably connected to the first end of air transfer conduit 255 to cool the air to be circulated in thawing chamber 105. Second air cooling unit 262 is located on the other side of the thawing chamber and is operably connected to the second end of the air transfer conduit 255 to cool the air to be circulated in thawing chamber 105. As shown in FIG. 1, in an aspect, apparatus 100 air cooling units 260 and 262 are located on opposite sides and are operably connected to transfer conduits 255, 257 and 259 at opposing ends of the transfer conduits to cool the air to be circulated in thawing chamber 105.

In an aspect, the location of the air heating unit and the air cooling units are exchanged as compared to the locations shown in FIGS. 1 and 2, such that the air cooling units are centrally located and air heating units are provided at the ends of the air transfer conduit(s).

An array of thermal sensors is located in the thawing chamber to measure the temperature at various locations. Any suitable temperature sensor may be used, including thermally sensitive resistors, resistance thermometers, thermocouples, a semiconductor-based temperature sensors placed on integrated circuits, and non-contact temperature sensing devices, such as an infrared sensor.

In a first aspect, ambient air temperature sensors are configured to measure the temperature of ambient air in at least three locations in the thawing chamber. In an aspect, ambient air temperature sensors are configured to measure the temperature at a location no closer than 5 cm to the meat to be thawed, so as to not register air that is locally cooled by the frozen meat. In an aspect, ambient air temperature sensors are configured to measure the temperature at a location no closer than 10 cm to the meat to be thawed. In an aspect, the plurality of ambient air temperature sensors are configured to measure the temperature at points that are symmetrically located in the thawing chamber. In an aspect, at least one of the ambient air temperature sensors is configured to measure the temperature at a location generally in the middle (i.e. within +/−20% of the midpoint of the length and width of the thawing chamber at any height) of the thawing chamber. In an aspect, at least one of the ambient air temperature sensors is configured to measure the temperature at a location generally at one side of the thawing chamber and at least one of the ambient air temperature sensors is configured to measure the temperature at a location generally at the opposing side of the thawing chamber (i.e. within +/−20% of the length or the width of the thawing chamber from the opposing walls of the thawing chamber at any height).

As shown in FIG. 2, ambient air temperature sensor 270 is located at one side of thawing chamber 105, ambient air temperature sensor 272 is located at the middle of thawing chamber 105, and ambient air temperature sensor 274 is located at the other side of thawing chamber 105. In an aspect, at least 3 ambient air temperature sensors are positioned at locations spaced at least 3 meters apart. In an aspect, at least 3 ambient air temperature sensors are positioned at locations spaced at least 5 meters apart. In an aspect, at least 4 ambient air temperature sensors are positioned at locations spaced at least 3 meters apart. In an aspect, at least 5 ambient air temperature sensors are positioned at locations spaced at least 3 meters apart. In an aspect, ambient air temperature sensors are positioned at locations identified to be representative of high and low temperature values of the ambient air in the thawing chamber. Measurement of the temperature of the ambient air in the thawing chamber in varied locations has been found to enhance the ability to control the temperature of the meat during the thawing process, so that the meat is not unevenly thawed and additionally so that all of the meat in the thawing chamber is thawed at the same relative rate.

At least one meat surface temperature sensor is configured to measure the temperature of a surface of a sample of meat in the thawing chamber to determine the surface temperature of the sample of meat. The ability to monitor surface temperature provides important temperature feedback to control the temperature of the meat during the thawing process, so that the meat is not unevenly thawed. In an aspect a plurality of meat samples are provided with meat surface temperature sensors at the surface of the respective samples of meat to determine the surface temperature of the meat sample, wherein these “surface temperature monitored meat samples” are located at spaced apart locations in thawing chamber 105. In an aspect, at least 3 surface temperature monitored meat samples are positioned at locations spaced at least 3 meters apart. In an aspect, at least 3 surface temperature monitored meat samples are positioned at locations spaced at least 5 meters apart. In an aspect, at least 4 surface temperature monitored meat samples are positioned at locations spaced at least 3 meters apart. In an aspect, at least 5 surface temperature monitored meat samples are positioned at locations spaced at least 3 meters apart.

At least one meat core temperature sensor is provided to measure the internal temperature of a sample of meat is provided in the thawing chamber. The ability to monitor core temperature provides important temperature feedback to control the temperature of the meat during the thawing process, so that the meat is not unevenly thawed. In an aspect a plurality of meat samples are provided with meat core temperature sensors, wherein these “core temperature monitored meat samples” are located at spaced apart locations in thawing chamber 105. In an aspect, at least 3 core temperature monitored meat samples are positioned at locations spaced at least 3 meters apart. In an aspect, at least 3 core temperature monitored meat samples are positioned at locations spaced at least 5 meters apart. In an aspect, at least 4 core temperature monitored meat samples are positioned at locations spaced at least 3 meters apart. In an aspect, at least 5 core temperature monitored meat samples are positioned at locations spaced at least 3 meters apart.

A climate control unit 280 is operably connected to the air circulation fan unit 240, the air heating unit 250, the air cooling unit 220 and 230 and the plurality of thermal sensors 270, 272, and 274 sensing ambient air temperature as well as the sensors measuring the surface temperature and core temperature of the meat to be thawed. The climate control unit is operably connected to the various components of the apparatus by wired connection, wireless connection, or a mixture of wired and wireless connections. The climate control unit in an aspect comprises a user interface to set control parameters for operation of the apparatus. The user interface may be any suitable component for receiving user input, such as switches, knobs, input key, touch screens, voice activated commands, and the like. The climate control unit in an aspect comprises communication and operation software and/or hardware to monitor conditions and operations of the various components of the apparatus. The climate control unit in an aspect comprises communication and operation software and/or hardware to report conditions and operations of the various components of the apparatus to a user. In an aspect, the climate control unit comprises one or more displays.

In an aspect, the climate control unit 280 comprises microcomputer intelligent control system and data collection system. In an aspect, the data collected during the thawing process can be assembled in a printable report of operation.

In an aspect, the climate control unit comprises monitoring and control functionality that measures the temperature of the ambient air in the thawing chamber and core temperature of meat sample, and controls the air heating unit and air circulation fan unit to provide an initial circulation of heated air into the thawing chamber via the air transfer conduit to provide rapid thawing. This initial circulation of heated air advantageously is a high temperature to effect rapid and efficient thawing of the meat in the thawing chamber. For example the initial circulation of heated air may be carried out to establish an ambient air temperature of from 20° C. to 40° C. The climate control unit continues to perform monitoring and control functions by additionally measuring the temperature of a surface of a sample of meat in the thawing chamber to confirm that the surface temperature of meat remains at a temperature of less than 4.4° C. As the surface temperature of meat increases from the initial temperature of no more than −18° C. to a temperature approaching 4.4° C., the climate control unit controls the air heating unit and air circulation fan unit to reduce the effective temperature of the ambient air in the thawing chamber to prevent overheating of the surface of the meat. In the event that the temperature of the ambient air in the thawing chamber is too high relative to the measured temperature of the surface of a sample of meat, the climate control unit may engage operation of the air cooling unit to quickly reduce the temperature of the ambient air in the thawing chamber to preferred levels. In an aspect, the climate control unit may alternate operation of the air heating unit and the air cooling unit to precisely control the temperature of the ambient air in the thawing chamber for rapid thawing while maintaining the surface temperature of meat at a temperature of less than 4.4° C.

In an aspect, the temperature profile of the ambient air in the thawing chamber may be determined by an algorithm based on the ratio of the internal temperature of a sample of meat in the thawing chamber as compared to the surface temperature of a sample of meat in the thawing chamber. In an aspect, the temperature profile of the ambient air in the thawing chamber may be a pre-programmed ramp function, with adjustment during the thawing process based on the surface temperature of a sample of meat in the thawing chamber. In an aspect, the temperature profile of the ambient air in the thawing chamber may be manually, controlled.

In an aspect, the apparatus further comprises a SCADA system (supervisory control and data acquisition) for continuously monitoring the process and providing accurate real time data and control operations.

In an aspect, the meat to be thawed is placed on a rack 285 that has openings in the horizontal surfaces on which the meat is placed. In an aspect, the openings are configured to permit air to circulate vertically through the thawing chamber in close proximity to the meat. In an aspect, the horizontal surfaces of the racks comprise at least 25% or 30% or 40% or 50% of open space. In an aspect, racks are positioned in at least two parallel rows extending the length l of the chamber, with a gap between the parallel rows of the racks, the gap positioned below the at least 6 air outlet openings and the at least 1 air intake opening. The relative location of the gap between the parallel rows of the racks and the at least 6 air outlet openings and the at least 1 air intake opening has been found to facilitate air flow in the chamber.

The apparatus is configured to be capable of controlling the climate of the thawing chamber to thaw at least 10 metric tons of meat from a frozen internal temperature of no more than −18° C. to a thawed internal temperature of from −2° C. to 4.4° C. while maintaining the surface temperature of meat at a temperature of less than 4.4° C. throughout the thawing process.

The apparatus is configured as a closed system during operation, so that no new air and no moisture in the form of vapor or steam is introduced to the thawing chamber during the thawing cycle. It is understood that perfect sealing of the system is not required for effective operation of the apparatus, but that for purposes of the present disclosure a “closed system” is understood to permit incidental introduction of outside air and moisture, provided that outside air and moisture is not purposefully introduced into the apparatus.

In an aspect, a method of thawing meat comprises:

Disposing at least 10 metric tons of frozen meat having a frozen internal temperature of no more than −18° C. in the thawing chamber, including at least any one or comibinations of the alternative aspects of the thawing chamber as described herein;

Operating the air heating unit and the air circulation fan unit to circulate heated air through the thawing chamber at a rate of at least 900 cubic meters per hour while monitoring the temperature of the ambient air in the thawing chamber in at least three locations, the surface temperature of meat to be thawed, and the core temperature of meat to be thawed; and

Controlling the climate of the thawing chamber to thaw the meat to a thawed internal temperature of from −2° C. to 4.4° C. while maintaining the surface temperature of meat at a temperature of less than 4.4° C. throughout the thawing process by controlled operation of the air heating unit and the air cooling unit to maintain a suitable thawing temperature.

In an aspect, the method is carried out so that all of the meat disposed in the thawing chamber is thawed in less than 24 hours.

In an aspect, the initially circulated heated air is distributed so that the ambient air temperature is maintained at a temperature of from about 20° C. to about 30° C. During the thawing process, the surface temperature of meat is monitored, and the ambient air temperature is lowered by reducing the heat generated by the air heating unit, or engaging the air cooling unit as necessary, to maintain the surface temperature of meat at a temperature of less than 4.4° C., while increasing the meat core temperature to a thawed internal temperature of from −2° C. to 4.4° C.

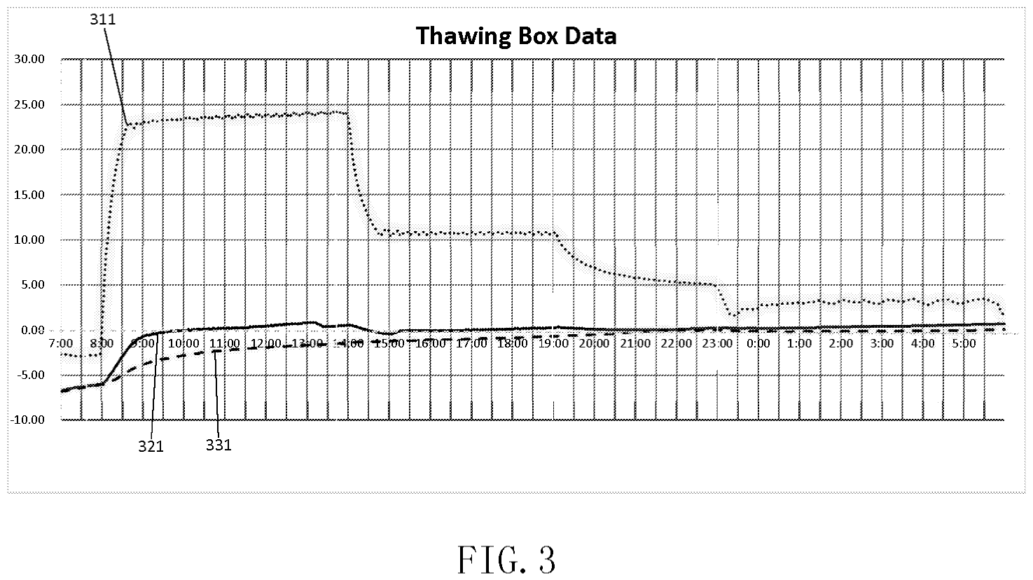

FIG. 3 is a graph showing temperature data of an example of a process for thawing meat using an apparatus as described herein. In an exemplary process, at least 10 metric tons of frozen meat is disposed in the thawing chamber, the meat having an initial meat surface temperature in a temperature range of −24° C. to −18° C. and an initial meat core temperature in a temperature range of −24° C. to −18° C. The air heating unit and the air circulation fan unit are activated to circulate heated air through the thawing chamber to increase the ambient air temperature to a target temperature of from about 20° C. to about 30° C. Due to the large amount of frozen meat in the thawing chamber, it takes some time for the ambient air temperature to reach the target temperature of from about 20° C. to about 30° C. During the time of increase of the ambient air temperature, the meat surface temperature and the meat core temperatures are monitored. The data shown on FIG. 3 is a partial temperature profile starting in mid-process. At the shown starting point of the data, the heating unit and the air circulation fan unit have been paused for a time, and the ambient temperature 311 is about −3° C. to −2° C. (reflecting the cooling effect from the frozen meat), the meat surface temperature 321 at the shown starting point of the data is in a temperature range of −7° C. to −6° C., and the meat core temperature 331 at the shown starting point of the data is in a temperature range of −7° C. to −6° C. Upon activation of the air heating unit and the air circulation fan unit to circulate heated air through the thawing chamber, the ambient air temperature quickly increases to a temperature of from about 23° C. to about 24° C. This increase in ambient air temperature results in a fairly rapid increase of the meat surface temperature to about 0° C., with a more gradual increase in the meat core temperature to a temperature of from about −3° C. to about −2° C.

When the meat surface temperature increases to a temperature of about 1° C., the heat output of the air heating unit is adjusted and/or the air cooling unit is engaged to provide an ambient air temperature of from about 10° C. to about 13° C. This ambient air temperature at this stage in the process causes the meat surface temperature to stabilize at a temperature of about 1° C., while permitting the meat core temperature to again gradually rise, now to a temperature of from about −0.5° C.

When the meat core temperature increases to a temperature of about −0.5° C., the heat output of the air heating unit is adjusted, and/or the air cooling unit is engaged to gradually provide an ambient air temperature of about 5° C. For example, in this stage the air heating unit is adjusted, and/or the air cooling unit is engaged to provide a gradual reduction of ambient air temperature from about 10° C. to about 5° C. over a time of about 4 hours. This ambient air temperature at this stage in the process causes the meat surface temperature to stabilize at a temperature of about 0° C., while permitting the meat core temperature to again gradually rise, now to a temperature that is also about 0° C. After this stage in the process, the air heating unit is adjusted, and/or the air cooling unit is engaged to provide an ambient air temperature of from about 2° C. to about 4° C. for a time of about 6 hours. This stage of the process is a chill storage phase, and may provide benefit in assuring that all of the meat in the thawing chamber is completely thawed.

In an aspect, the temperature profile of the ambient air in the thawing chamber during the thawing process is determined by an algorithm based on the ratio of the internal temperature of a sample of meat in the thawing chamber as compared to the surface temperature of a sample of meat in the thawing chamber.

In an aspect, the temperature profile of the ambient air in the thawing chamber during the thawing process is a pre-programmed ramp function, with adjustment during the thawing process based on the surface temperature of a sample of meat in the thawing chamber.

In an aspect, the controlling of the climate of the thawing chamber as described above is carried out in at least four phases, wherein

In a first phase, the air heating unit and the air circulation fan unit are activated to circulate heated air through the thawing chamber to increase the ambient air temperature to a target temperature of from about 20° C., to about 30° C. until the meat surface temperature increases to a temperature of from −2° C., to 4.4° C. and the meat core temperature increases to a temperature of from about −5° C., to about −2° C.;

In a second phase after the first phase, the air heating unit and the air circulation fan unit are activated to circulate heated air through the thawing chamber to provide the ambient air temperature at a target temperature of from about 5° C., to about 15° C. until the meat surface temperature is at a temperature of from −2° C., to 4.4° C. and the meat core temperature increases to a temperature of from about −1° C., to about 0° C.;

In a third phase after the second phase, the air heating unit and the air circulation fan unit are activated to circulate heated air through the thawing chamber to reduce the ambient air temperature from a target temperature of from about 5° C., to about 15° C., to a target temperature of from about 4° C., to 6° C. over a time of from about 3 to about 5 hours and until the meat surface temperature is at a temperature of from −0.5° C., to 4.4° C. and the meat core temperature increases to a temperature of from about −0.5° C., to 4.4° C.; and

In a fourth phase after the third phase, the air heating unit and the air circulation fan unit are activated to circulate heated air through the thawing chamber to provide the ambient air temperature at a target temperature of from about 2° C., to 4.4° C. until the meat surface temperature is at a temperature of from −0.5° C., to 4.4° C. and the meat core temperature increases to a temperature of from about −0.5° C., to 4.4° C.

In an aspect, in the first phase, the air heating unit and the air circulation fan unit are activated to circulate heated air through the thawing chamber to increase the ambient air temperature to a target temperature of from about 20° C., to about 30° C. until the meat surface temperature increases to a temperature of from −1° C., to 2° C. and the meat core temperature increases to a temperature of from about −3° C., to about −2° C.; and

in the second phase after the first phase, the air heating unit and the air circulation fan unit are activated to circulate heated air through the thawing chamber to provide the ambient air temperature at a target temperature of from about 8° C., to about 13° C. until the meat surface temperature is at a temperature of from 0° C., to 2° C. and the meat core temperature increases to a temperature of from about −1° C., to about 0° C.

In an aspect, in the third phase, the air heating unit and the air circulation fan unit are activated to circulate heated air through the thawing chamber to reduce the ambient air temperature over a time of from about 3.5 to about 4.5 hours.

In an aspect, the meat to be thawed is selected from meats including those obtained from bovine, porcine, equine, caprine, ovine, avian animals, or any animal commonly used for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich. In an aspect, the meat to be thawed is selected from beef, pork, turkey or chicken. In an aspect, the meat to be thawed is selected from chicken and pork.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the aspect of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various aspects, any of the terms “comprising”, “consisting essentially of” and “consisting of” used in the description of an aspect may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. An apparatus for thawing meat comprising:
a thawing chamber defined by a floor, at least four walls and a ceiling, the thawing chamber having a length of at least 6 meters, a width of at least 1.9 meters, and a height of at least 1.9 meters;
an air circulation fan unit operably connected by an air transfer conduit to at least 6 air outlet openings for introducing air into the thawing chamber and at least 1 air intake opening for removing air from the thawing chamber, the air circulation fan unit being capable of moving a volume of air in and out of the thawing chamber as a closed system at a rate of at least 900 cubic meters per hour;
an air heating unit operably connected to the air transfer conduit;
an air cooling unit operably connected to the air transfer conduit;
an array of thermal sensors in the thawing chamber comprising:
a) ambient air temperature sensors configured to measure the temperature of ambient air in at least three locations in the thawing chamber,
b) a meat surface temperature sensor configured to measure the temperature of a surface of a sample of meat in the thawing chamber, and
c) a meat core temperature sensor configured to measure the internal temperature of a sample of meat in the thawing chamber; and
a climate control unit operably connected to the air circulation fan unit, the air heating unit, the air cooling unit and the thermal sensors;
the apparatus being capable of controlling the climate of the thawing chamber to thaw at least 10 metric tons of meat from a frozen internal temperature of no more than −18° C., to a thawed internal temperature of from −2° C., to 4.4° C. while maintaining the surface temperature of meat at a temperature of less than 4.4° C., throughout the thawing process;
wherein the apparatus is configured so that no new air and no added moisture is introduced to the thawing chamber during the thawing cycle.

2. The apparatus of claim 1, wherein the at least 6 air outlet openings and the at least 1 air intake opening are located proximate to the ceiling.

3. The apparatus of claim 2, wherein the at least 1 air intake opening is centrally located in the thawing chamber, and the at least 6 air outlet openings are symmetrically located with respect to the at least 1 air intake opening.

4. The apparatus of claim 2, wherein
the at least 1 air intake opening is centrally located in the thawing chamber, and is configured to draw air from the thawing chamber into the air heating unit that additionally comprises the air circulation fan unit; and
the air circulation fan unit is operably connected with air circulation tunnels comprising the at least 6 air outlet openings, the air circulation tunnels extending from the air circulation fan unit substantially parallel to the ceiling of the chamber toward opposing walls.

5. The apparatus of claim 1, wherein the air circulation fan unit is capable of circulating air through the thawing chamber at a rate between 9600 cubic meters to 48000 cubic meters per hour.

6. The apparatus of claim 1, wherein the thawing chamber has a length l of from 6 meters to 25 meters, a width w of 1.9 meters to 4 meters, and a height h of 1.9 meters to 5 meters.

7. The apparatus of claim 1, wherein the thawing chamber has a length l of from 7 meters to 20 meters, a width w of 2 meters to 4 meters, and a height h of 2 meters to 3 meters.

8. The apparatus of claim 1, wherein the air transfer conduit is fabricated from a food grade cloth comprising at least one component that inhibits the growth of bacteria in the cloth.

9. The apparatus of claim 1, wherein the air outlet openings are spaced apart a distance of from about 1 meter to about 5 meters.

10. The apparatus of claim 1, wherein at least 3 of the ambient air temperature sensors are configured to measure the temperature at locations spaced at least 3 meters apart.

11. The apparatus claim 1, wherein at least 5 of the ambient air temperature sensors are configured to measure the temperature at locations spaced at least 3 meters apart.

12. The apparatus claim 1, wherein the air cooling unit comprises a first air cooling unit operably connected to a first end of the air transfer conduit and a second air cooling unit operably connected to a second end of the air transfer conduit.

13. The apparatus claim 1, further comprising a SCADA system (supervisory control and data acquisition) for continuously monitoring the process and providing accurate real time data and control operations.

14. A method of thawing meat, comprising:
Providing an apparatus of claim 1;
Disposing at least 10 metric tons of frozen meat having a frozen internal temperature of no more than −18° C., in the thawing chamber;
Operating the air heating unit and the air circulation fan unit to circulate heated air through the thawing chamber at a rate of at least 900 cubic meters per hour while monitoring the temperature of the ambient air in the thawing chamber in at least three locations, the surface temperature of meat to be thawed, and the core temperature of meat to be thawed; and
Controlling the climate of the thawing chamber to thaw the meat to a thawed internal temperature of from −2° C., to 4.4° C. while maintaining the surface temperature of meat at a temperature of less than 4.4° C., throughout the thawing process by controlled operation of the air heating unit and the air cooling unit to maintain a suitable thawing temperature.

15. The method of claim 14, wherein the initially circulated heated air is at a temperature of from about 20° C., to about 30° C.

16. The method of claim 14, wherein the temperature profile of the ambient air in the thawing chamber during the thawing process is determined by an algorithm based on the ratio of the internal temperature of a sample of meat in the thawing chamber as compared to the surface temperature of a sample of meat in the thawing chamber.

17. The method of claim 14, wherein the temperature profile of the ambient air in the thawing chamber during the thawing process is a pre-programmed ramp function, with adjustment during the thawing process based on the surface temperature of a sample of meat in the thawing chamber.

18. The method of claim 14, wherein the controlling of the climate of the thawing chamber is carried out in at least four phases, wherein
In a first phase, the air heating unit and the air circulation fan unit are activated to circulate heated air through the thawing chamber to increase the ambient air temperature to a target temperature of from about 20° C., to about 30° C. until the meat surface temperature increases to a temperature of from −2° C., to 4.4° C. and the meat core temperature increases to a temperature of from about −5° C., to about −2° C.;
In a second phase after the first phase, the air heating unit and the air circulation fan unit are activated to circulate heated air through the thawing chamber to provide the ambient air temperature at a target temperature of from about 5° C., to about 15° C. until the meat surface temperature is at a temperature of from −2° C., to 4.4° C. and the meat core temperature increases to a temperature of from about −1° C., to about 0° C.;
In a third phase after the second phase, the air heating unit and the air circulation fan unit are activated to circulate heated air through the thawing chamber to reduce the ambient air temperature from a target temperature of from about 5° C., to about 15° C., to a target temperature of from about 4° C., to 6° C. over a time of from about 3 to about 5 hours and until the meat surface temperature is at a temperature of from −0.5° C., to 4.4° C. and the meat core temperature increases to a temperature of from about −0.5° C., to 4.4° C.; and
In a fourth phase after the third phase, the air heating unit and the air circulation fan unit are activated to circulate heated air through the thawing chamber to provide the ambient air temperature at a target temperature of from about 2° C., to 4.4° C. until the meat surface temperature is at a temperature of from −0.5° C., to 4.4° C. and the meat core temperature increases to a temperature of from about −0.5° C., to 4.4° C.

19. The method of claim 18, wherein
In the first phase, the air heating unit and the air circulation fan unit are activated to circulate heated air through the thawing chamber to increase the ambient air temperature to a target temperature of from about 20° C., to about 30° C. until the meat surface temperature increases to a temperature of from −1° C., to 2° C. and the meat core temperature increases to a temperature of from about −3° C., to about −2° C.; and
In the second phase after the first phase, the air heating unit and the air circulation fan unit are activated to circulate heated air through the thawing chamber to provide the ambient air temperature at a target temperature of from about 8° C., to about 13° C. until the meat surface temperature is at a temperature of from 0° C., to 2° C. and the meat core temperature increases to a temperature of from about −1° C., to about 0° C.

20. The method of claim 18, wherein in the third phase, the air heating unit and the air circulation fan unit are activated to circulate heated air through the thawing chamber to reduce the ambient air temperature over a time of from about 3.5 to about 4.5 hours.

21-23. (canceled)
